(19) United States
(12) Patent Application Publication
(10) Pub. No.: US 2025/0290347 A1
(43) Pub. Date: Sep. 18, 2025

(54) EXIT DEVICE WITH DAMPER

(71) Applicant: Sargent Manufacturing Company, New Haven, CT (US)

(72) Inventor: Jason Sloan, Middlebury, CT (US)

(73) Assignee: Sargent Manufacturing Company, New Haven, CT (US)

(21) Appl. No.: 19/028,515

(22) Filed: Jan. 17, 2025

Related U.S. Application Data
(60) Provisional application No. 63/564,290, filed on Mar. 12, 2024.

(51) Int. Cl. E05B 17/00; E05B 65/10

(52) U.S. Cl. CPC E05B 17/0045; E05B 65/1053

(57) ABSTRACT

An exit device that minimizes noise is disclosed. In some embodiments the exit device may include an actuator such as a push bar, and a door bolt. In other embodiments the device may include an actuator such as a push bar, a door bolt and an arm. The exit device includes a damper operatively coupled in a manner to reduce movement of the components when returning to an unactuated position from an actuated or partly actuated position. In some embodiments the damper is operatively coupled to door bolt.

### CROSS-REFERENCE TO RELATED APPLICATIONS

This application claims the benefit under 35 U.S.C. 119(e) of U.S. Provisional Application No. 63/564,290, filed Mar. 12, 2024, and entitled “EXIT DEVICE WITH DAMPER,” the entire contents of which is incorporated herein by reference.

### FIELD

Disclosed embodiments are related to an exit device that offers a silenced or mostly silenced actuator return.

### BACKGROUND

Exit devices are frequently used to secure and open doors in high traffic areas leading to repeated use. When an exit device returns to its unactuated or closed state from its actuated or opened state, the mechanical components of the device interact with each other to produce a noise, which can be disruptive in some environments.

### SUMMARY

In some embodiments, an exit device is disclosed. The exit device has a first position and a second position. The exit device includes an actuator movable from a first unactuated position to a second actuated position and an arm operatively coupled to the actuator. The arm is movable from a first arm position to a second arm position. Movement of the actuator first unactuated position to a second actuated position moves the arm from the first arm position to the second arm position. A door bolt is operatively coupled to the arm. The door bolt is moveable from a first door bolt position to a second door bolt position. Movement of the arm from the first arm position to the second arm position moves the door bolt from the first door bolt position to the second door bolt position. The exit device also includes at least one damper operatively connected to at least one of the actuator, the arm and the door bolt. The damper is configured to minimize noise associated with the movement of at least one of the actuator, the arm, and the door bolt.

In other embodiments, an exit device with an actuator movable from a first unactuated position to a second actuated position is disclosed. The exit device additionally includes a door bolt operatively coupled to the actuator. The door bolt is moveable from a first door bolt position to a second door bolt position. Movement of the actuator from the first unactuated position to the second actuated position moves the door bolt from the first door bolt position to the second door bolt position. The exit device also includes at least one damper operatively connected to at least one of the actuator, and the door bolt. The damper is configured to minimize noise associated with the movement of at least one of the actuator, and the door bolt.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 depicts an exit device on a door, with the exit device having a push bar actuator;

FIG. 2a shows a top view of a latch end of an exit device in a first state;

FIG. 2b shows latch end of the exit device of FIG. 2a in a second state;

FIG. 3a shows a side view of a portion of an exit device in the first state;

FIG. 3b shows a side view of a portion of an exit device in the second state;

FIG. 4a a partial rear view of the exit device showing a damper in a first state;

FIG. 4b a partial rear view of the exit device showing the damper in a second state and,

FIG. 5 is an alternative embodiment of the exit device in a first state where the damper is operatively connected to a push bar.

### DETAILED DESCRIPTION

The metal components within an exit device can create a disruptive noise when they return to their resting position after activation. Every time an actuator is pressed, a torque is generated within the exit device causing the metal components of the device knock together.

The Inventors have recognized that this can be an issue in settings where people are resting or sleeping near high traffic areas, such as hospitals, care homes and facilities. In care homes and facilities, residents and guests near high traffic areas may not be able to leave their rooms to seek reprieve from the disturbance. Moreover, hospitals have been striving to limit the development of sleep wake dysfunction in their inpatient facilities. Environmental factors such as excessive light and noise have been associated with disturbances in patients' sleep quality and may lead to patients developing such dysfunction during their stay. Likewise, the quality of a patients' sleep has been inversely associated with the duration of their stay, and insufficient sleep can impair patients' recovery.

The Inventors also recognize that this can be an issue in other locations, such as universities. Large lecture halls can accommodate large numbers of students, resulting in multiple people exiting the lecture hall. Also, because there are often multiple classes occurring at once, the doors to these rooms often automatically close to minimize one lecture interfering with another. Therefore, throughout a lecture, an actuator may noisily return to its closed position multiple times. Moreover, depending on the lecturer, the noise created by the exit device may be more intense than the speaker, therefore, it may completely obstruct portions of the lecture.

Likewise, the noise created by an exit device can impact exams taken in these lecture halls. Not all test takers taking an exam complete it at the same time, and in most cases, they can leave once they are finished; therefore, there is an increase in noise from the exit device as more test takers finish their exam and leave. This may impact those who take longer to complete exams more, because, as they are struggling to complete an exam, more people are leaving, and more disruptions are created.

Furthermore, in these facilities, it is unlikely that those who are entering or exiting the space can or will manually return the actuator to its resting position because they are focused on other matters, and current exit devices do not include an arrangement to mitigate sound disruptions related to the operation of the exit device.

Considering the aforementioned shortcomings of current exit devices, the Inventors have recognized that a damper can be used to limit or minimize disturbances created by exit devices. As such, the Inventors have created an improved exit device having a damper that slows the return of the moveable components in the exit device when it is moving in the return direction from its actuated position to its resting position. The Inventors have found that a dampened return can mitigate noise generation.

The Inventors have recognized that when a user releases an actuated push bar, a damper operatively coupled to the latch or bolt can slow its return, minimizing the forces within the device. The damper may also slow the return of the push bar. In this regard, the push bar and latch are operatively coupled such that dampening the return of one may dampen the return of the other. Minimizing these forces minimizes the noise produced.

The exit device may contain an actuator, which may be a push bar. When the push bar is pressed the actuator moves to a second actuated position, the exit device unlatches from the doorway and the door can open. Once the user releases the actuator, it will return to its initial first unactuated position without any additional user input. This may be via a spring return within the actuator that basis the device towards the closed position.

The Inventors have also recognized that there should be minimal or no increase in the effort required for a user to actuate the push bar associated with the exit device. In some embodiments, the damper that slows the return movement of the device to its resting position is a one-way limiter that acts to dampen the return but has little to no impact on the actuation. In one embodiment, the one-way limiter is a rotary spin damper, however other dampers may be used. These may include, but are not limited to, linear dampers, axial dampers, two-way rotary spin limiter, air springs, or any device that could slow the return of the actuator. Furthermore, the current disclosure is not intended to limit the type of one-way rotary spin limiters. Multiple types of one-way rotary spin limiters may be used within the exit device such as, but not limited to, oil-based or friction-based limiters.

In some embodiments, the damper is connected to the door bolt through a rotary spin limiter assembly. However, in other embodiments the damper on the improved exit device may be coupled with the actuator or the push bar. Additionally, the damper may be associated directly with the door bolt. In some embodiments, the damper may only interact with the movable components upon return and not upon actuation. In this regard the damper is decoupled from the moveable components when the device is being actuated and only coupled to moveable components when the component moves to its initial/rest position.

Moreover, the improved exit device may include various moveable components operatively coupled to the push bar configured to enable operation of the exit device. It should be appreciated that the claimed improvements of the exit device may be combined with other improvements separately claimed or unclaimed to create a quieter exit device.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

As discussed herein, according to some embodiments the exit device includes arrangements to reduce the noise associated with operation of the exit device.

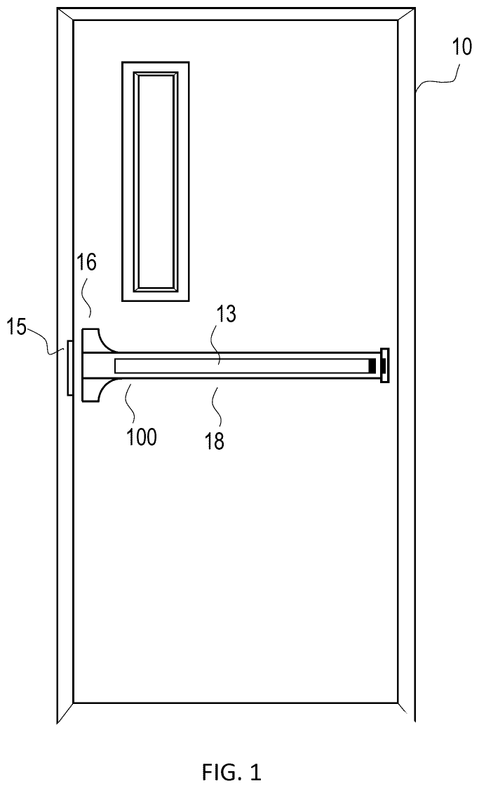

As discussed herein, the exit device is configured to be coupled to a door according to some embodiments. For example, the exit device is shown coupled to a door in the depicted embodiments of FIG. 1 More specifically, a door system 10 includes an exit device 100 having a latching end 16 and an actuation end 18. A push bar 13 is disposed on the actuation end. The push bar actuates the exit device, moving it from its first to its second position and securing the door to the door frame.

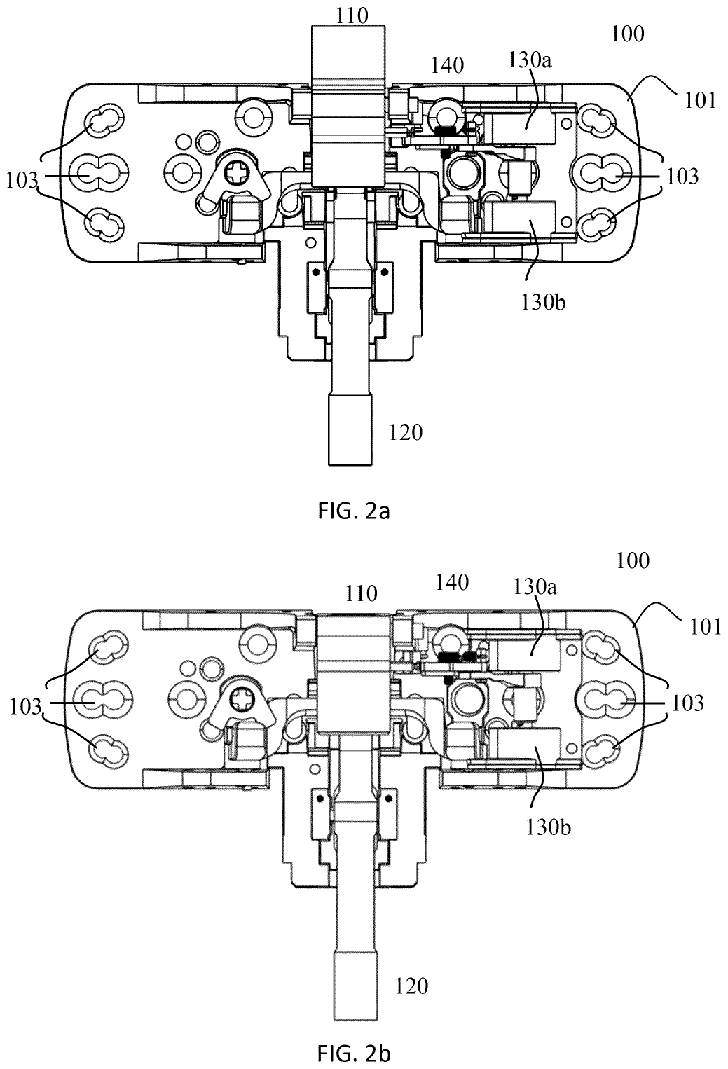

As illustrated in the depicted embodiments of FIGS. 1, 2a and 2b, the exit device 100 is configured to be coupled to a door. The latching end 16 includes a base 101. The base 101 secures the latching end of the exit device to the door and provides support for its operation. The latching end of the exit device may be rigidly connected to a door via the fastener holes 103 in the base with fasteners, such as screws. However, other means of securing the exit device to a door may be used. Furthermore, the base supports the movable components of the latching end of the exit device; this includes a door bolt 110, an arm 120, a damper 130 and a lever 142.

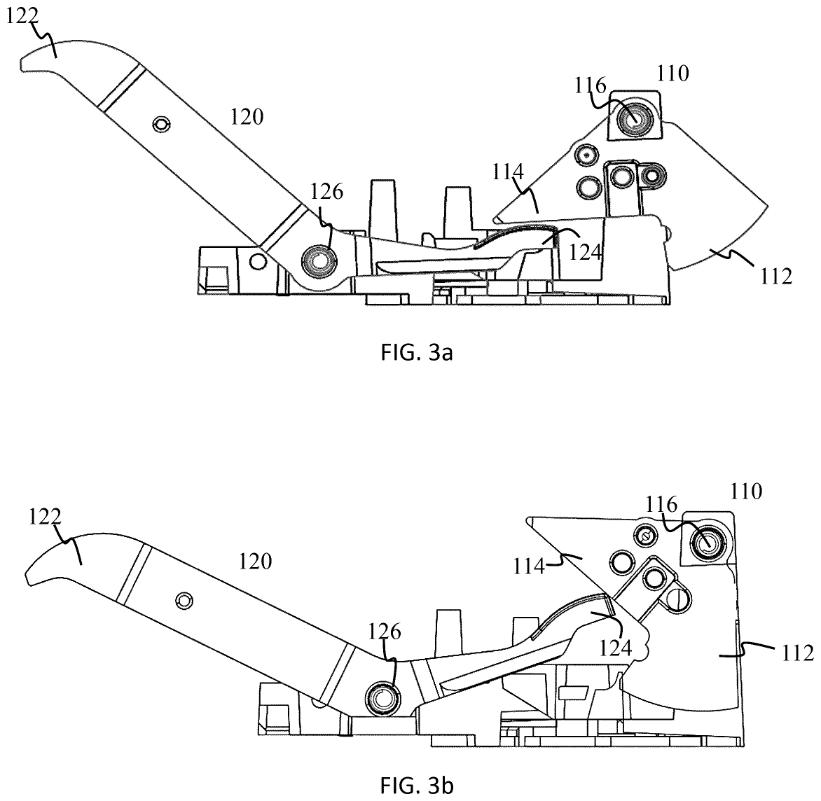

The door bolt 110 (e.g., latch or bolt) contains a bolt face 112, as shown in FIG. 3a. The bolt face latches into a door plate 15 on a door frame. On the opposing side of the bolt face 112 is an arm interface portion 114, and between the two is a connection point 116. It should be appreciated that the term “bolt” may be used interchangeably herein with the term “latch”, as the present disclosure is not limited to the type of component that engages with the door plate or the door frame.

The door bolt 110 can be rotated though the connection point 116, which rotatably connects the door bolt to the base. The door bolt has a first position and a second position; the two positions occur at opposing rotational maximums of the door bolt that is allowed by the exit device. When the exit device is in its first position, the door bolt face 112 is at its highest position of its to rotational arch relative to the base 101, conversely, when the exit device is in its second position, the arm interface portion 114 of the door bolt is at the highest point of its rotational arc relative to the base 101. When the exit device is in its first state, the door bolt face 112 is secured in a door plate 15 or is extended beyond the door.

In the depicted embodiment, the connection point 116 (which can be a hole and associated pin) is used to rotatably connect the door bolt the base. However, another means of rotatably connecting the door bolt to the base may be substituted, as the present disclosure is not limited in this regard.

FIGS. 3a and 3b illustrate side views of the exit device in a first and second position respectively. As shown in FIGS. 3a and 3b the exit device includes an arm 120. The arm 120 contains a door bolt interface portion 124, an actuator interface portion 122 and a connection point 126. The arm 110 is operatively coupled to the door bolt 110 via the door bolt interface portion 124 through the arm interface portion 114 of the door bolt. Additionally, and not depicted, the arm 120 may be operatively coupled to an actuator with the actuator interface portion 122.

The arm connection point 126 rotatably connects the arm 120 to the base 101. In the depicted embodiment, the arm connection point 126 is formed with an arm hole and a pin. The arm hole is located between the door bolt interface portion 124 and the actuator interface portion 122. The pin inserted into the arm hole rotatably secures the arm to the base. However, another structure may be used to rotatably connect the arm to the base.

The arm 120 has a first position and a second position based on its degree of rotation about the connection point. The arm 120 will be at a first position when the device is at rest. The arm will be in a second position when a force in direction A (shown to be downward) is exerted on the arm. This force rotates the arm about the arm connection point. Consequently, as the actuator interface portion 122 of the arm rotates closer to the base 101 the door bolt interface portion 124 rotates further from the base, and the arm 120 rotates the door bolt 110 into its second position.

As stated above, the exit device includes a damper 130. The damper slows the movement of one or more of the components of the exit device from their second position to their first position. The components of the exit device may include an actuator, an arm, and a door bolt. By slowing the return of one or more of these components the noise associated with the exit device may be minimized.

In the depicted embodiment, the damper includes two one-way rotary spin limiters 130a and 130b. The limiter 130a that is positioned closer to the door bolt and is facing the actuator resists clockwise rotation. Conversely, the limiter 130b that is positioned closer to the actuator and is facing the door bolt resists counterclockwise motion.

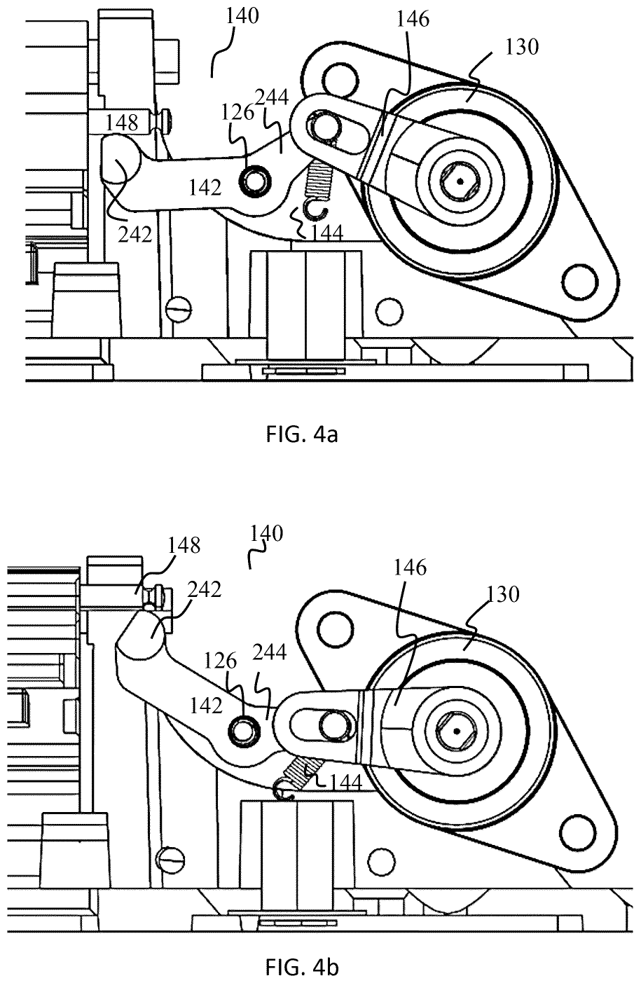

In the depicted embodiment illustrated in FIGS. 4a and 4b, the damper 130 is operatively connected to the door bolt 110, the arm 120, and the actuator via a rotary spin limiter connection assembly 140. The rotary spin limiter connection assembly 140 includes a lever 142, a projection 148, a hinge point, an extension spring 144, and a connector 146. However as detailed above, other mechanisms may be used to slow the return of the arm to its first position.

The projection 148 extends from the door bolt 110 and is oriented parallel to the pin. As the door bolt moves between its first and second position, the projection 148 will rotate with it. The projection operatively couples the door bolt to the lever 142. Also, although the depicted embodiment uses a projection, other means of functionally coupling the door bolt to the lever are possible, as the present disclosure is not so limited.

The lever includes three components: a projection interface portion 242, a hinge point 126, and a lever head 244. The projection interface portion operatively connects the lever 142 to the projection. This connection causes the lever to move with the downward movement of the door bolt 110.

The hinge point, located between the projection interface portion 242 and the lever head 244, rotatably connects the lever 142 to the base 101. The lever will have a first and second position based on the rotational extremes permitted by the device. In the lever's first position, the door bolt interface portion 242 will be at its lower extreme; while in its second position, the door bolt interface portion of the lever will be at its upper extreme.

The lever 142 includes a lever head 244. When lever is in its first position, the lever head will be at its upper extreme relative to the base, and when the lever is in its second position, the lever head will be at its lower extreme relative to the base. In the depicted embodiment, the lever head operatively connects the lever to an extension spring 144 and a connector 146.

The extension spring 144 connects the lever head 244, to a point on the exit device that is below the second position of the lever head. This point may be on the base 101. When the lever 142 is in its first position, the extension spring is fully extended. The spring biases the lever head 244 downward. However, the lever is prevented from rotating into its second position by the projection 148 interacting with the projection interface portion 242. Therefore, when the door bolt rotates upward from first position to second position, the projection moves upward, and the door bolt interface portion of the lever also moves upward.

The depicted embodiment is not limiting in this regard, and the extension spring may be placed anywhere on the lever. One should note however, that the side of the extension spring not connected to the lever, its second connection point, to may also be associated with another portion of the exit device. If extension spring connection point is between the lever head and the pin, then the second connection point of the spring will be at a point that is lower than the extension spring connection point when the lever head is at its lowest rotational extreme. Alternatively, if extension spring connection point is between the projection interface portion and the pin, then the second connection point of the extension spring will be at a point that is higher than the extension spring connection point when the projection interface position is at its highest rotational extreme.

Furthermore, the extension spring may not be a spring. Instead, the extension spring may be an elastic or similar material that biases the lever to follow the projection.

In the depicted embodiment, the connector 146 extends from the lever head 244. The connector 146 connects the lever 142 to the damper 130. The connector is movably coupled to the lever head and securely connected to the damper. When the lever 142 moves from the first position to the second position or the second position to the first position the connector rotates with the rotary speed limiter. In the depicted embodiment, the connector is a separate component, however the connector may be continuous with the damper.

Additionally, the depicted embodiment is not limiting as to the location of the connector on the lever. The connector may be connected to any point on the lever. However, if the connector is connected between the hinge portion and the projection interface portion of the lever, then the direction of the damper may need to be changed. For example, if the connector is connected to a point between the hinge portion and the lever head, like in the disclosed embodiment, then the one-way rotary spin limiter resists counterclockwise movement. However, in an alternative configuration, when the connector is connected to a point between the hinge portion and the projection interface portion, the one-way rotary spin limiter may resist clockwise movement.

In the present embodiment a one-way rotary spin limiter is described, however, the present disclosure is not intended to be limiting, and other dampers may be used in conjunction with various connectors with different connection types. Alternatively, an exit device may include a damper without a lever, a connector or a lever and a connector, as the present disclosure is not limited in this regard.

In the present embodiment a one-way rotary spin limiter is described, however, the present disclosure is not intended to be limiting, and other dampers may be used in conjunction with various connectors with different connection types. Alternatively, an exit device may include a damper without a lever, a connector or a lever and a connector, as the present disclosure is not limited in this regard.

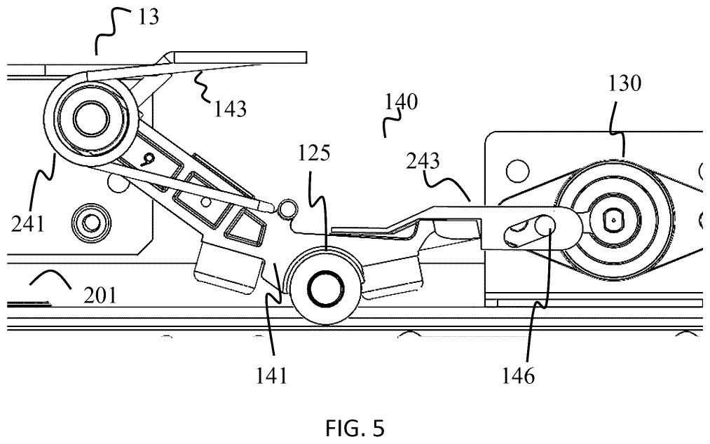

FIG. 5 depicts an alternative embodiment of the exit device. In this embodiment the damper 130 is operatively connected to a push bar 13. In this regard, though the damper 130 acts to also dampen the latch motion, the damper 130 in the embodiment of FIG. 5 is more directly connected to the push bar 13 than it is to the latch.

The push bar 13 has a first position and second position. When the push bar is actuated, the push bar moves from the first to the second position. When the actuation of the push bar stops, the push bar moves from the second push bar position to the first push bar position. In the first position, the push bar will be further from a push bar base 201 than when it is in its second position.

The push bar 13 and damper assembly includes a push bar base 201. The push bar base may include a damper assembly portion, supporting the damper, and a push bar portion, which supports the push bar. The damper assembly portion may be anywhere along the push bar portion. This base secures the assembly to the door and may or may not be continuous with base 101. In the depicted alternative embodiment, the damper assembly portion is on the actuation end 18 of the door. However, it should be appreciated that the present disclosure is not limited in this regard, and the damper may be connected anywhere on the push bar.

In the depicted alternate embodiment, the damper 130 is operatively connected to the push bar 13 with a lever 143. The lever includes three components: a push bar portion 241, a hinge point 125, and a damper interface 243. The push bar portion of the lever operatively connects the lever to the push bar so that the lever moves with the push bar as the push bar is actuated.

The hinge point, located between the push bar portion 241 and the damper interface 243, rotatably connects the lever 141 to the base 201. The lever 141 will have a first and second position based on the rotational extremes permitted by the device. In the lever's first position, the push bar portion 242 will be at its upper extreme; while in its second position, the push bar portion of the lever will be at its lower extreme. In the depicted alternative embodiment, the connection point is constructed of a pin and a hole. However, other means of rotatably connecting the lever to the base may be substituted, as the present disclosure is not limited in this regard.

In this embodiment, the spring element 143 is a torsion spring. The spring is connected to the lever at its first end, and the push bar at its second end, while the center of the torsion spring is connected the push bar portion of the lever. These connections allow for the device to operate while ensuring that the lever and the push bar return to their first positions at the same rate. Although a torsion spring is shown in this embodiment, other means of securing the push bar to the lever are contemplated. Furthermore, the spring element may be secured to other connection point locations.

In FIG. 5 the lever 143 is connected to a damper 130 with a connector 146. The connector is slidably connected to the damper and securely connected to the lever. When the damper interface 243 of the lever moves from its first position to its second position, the connector rotates upward with the damper. Additionally, when the damper interface of the lever moves from its second position to its first position, the damper, through the connector, resists rotating downward.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. An exit device with a first position and a second position comprising:
an actuator movable from a first unactuated position to a second actuated position;
an arm operatively coupled to the actuator, wherein the arm is movable from a first arm position to a second arm position, and wherein the movement of the actuator first unactuated position to a second actuated position moves the arm from the first arm position to the second arm position;
a door bolt operatively coupled to the arm, wherein the door bolt is moveable from a first door bolt position to a second door bolt position, and wherein the movement of the arm from the first arm position to the second arm position moves the door bolt from the first door bolt position to the second door bolt position; and
at least one damper operatively connected to at least one of the actuator, the arm and the door bolt, wherein the damper is configured to minimize noise associated with the movement of at least one of the actuator, the arm and the door bolt.

2. The exit device of claim 1, wherein the actuator is a push bar.

3. The exit device of claim 1, wherein the at least one damper is a one-way damper, wherein the damper is configured to minimize noise associated with movement in the return direction of at least one of the actuator, the arm and the door bolt.

4. The exit device of claim 3, wherein the at least one one-way damper is a rotary speed limiter.

5. The exit device of claim 3, wherein the at least one damper comprises two one-way dampers, wherein a first damper is configured to minimize noise associated with movement in the return direction of at least one of the actuator, the arm and the door bolt and a second damper is configured to minimize noise associated with movement in the actuation direction.

6. The exit device of claim 1, wherein the at least one damper is a linear damper.

7. The exit device of claim 1, further comprising a lever having a first end operatively coupled to the door bolt and a second end operatively connected to damper.

8. The exit device of claim 7, further comprising a spring configured to bias the lever to follow the door bolt from the first position to the second position.

9. An exit device comprising:
an actuator movable from a first unactuated position to a second actuated position;
a door bolt operatively coupled to the actuator, wherein the door bolt is movable from a first door bolt position to a second door bolt position, and wherein the movement of the actuator first unactuated position to a second actuated position moves the door bolt from the first door bolt position to the second door bolt position; and
at least one damper operatively connected to at least one of the actuator, and the door bolt, wherein the damper is configured to minimize noise associated with the movement of at least one of the actuator, and the door bolt.

10. The exit device of claim 9, wherein the actuator is a push bar.

11. The exit device of claim 9, wherein the at least one damper is a one-way damper, wherein the damper is configured to minimize noise associated with movement in the return direction of at least one of the actuator, the arm and the door bolt.

12. The exit device of claim 11, wherein the at least one one-way damper is a rotary speed limiter.

13. The exit device of claim 11, wherein the at least one damper comprises two one-way dampers, wherein a first damper is configured to minimize noise associated with movement in the return direction of at least one of the actuator, the arm and the door bolt and a second damper is configured to minimize noise associated with movement in the actuation direction.

14. The exit device of claim 9, wherein the at least one damper is a linear damper.

15. The exit device of claim 9. further comprising a lever having a first end operatively coupled to the door bolt and a second end operatively connected to damper.

16. The exit device of claim 15. further comprising a spring configured to bias the lever to follow the door bolt from the first position to the second position.
